(19) United States
(12) Patent Application Publication
(10) Pub. No.: US 2007/0097551 A1
(43) Pub. Date: May 3, 2007

(54) Method and Structure for Integrated High Density Memory Device

(75) Inventor: Xiao (Charles) Yang, Cupertino, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Xiao ("Charles") Yang

(21) Appl. No.: 11/554,503

(22) Filed: Oct. 30, 2006

Related U.S. Application Data
(60) Provisional application No. 60/732,448, filed on Oct. 31, 2005.

(51) Int. Cl. G11B 5/48

(52) U.S. Cl. 360/240

(57) ABSTRACT

The present invention provides a method and device for fabricating high density memory device. Similar to a Hard Disk Drive (HDD), the integrated memory device is consisted with a rotating media plate and a Read/Write (R/W) head on a movable suspension. Unlike HDD where the media plate is coupled to a motor, the media plate is micro fabricated on a semiconductor substrate and is also a motor which is actuated and rotated by electrostatic forces. The head suspension is also micro fabricated and anchored to an electrostatic comb drive micro actuator. Control IC can also be integrated on-chip with the integrated memory device as well as acceleration sensing devices such as MEMS accelerator for anti-shock measures. The integrated disk storage device is fabricated by conventional semiconductor and MEMS fabrication process technology.

### CROSS-REFERENCES TO RELATED APPLICATIONS

This application claims priority to provisional application Ser. No. 60/732,448; filed on Oct. 31, 2005; commonly assigned, and of which is hereby incorporated by reference for all purposes.

### BACKGROUND OF THE INVENTION

This present invention relates to a method and structure for fabricating a high density memory device. Hard Disk Drive (HDD) and solid state memory devices such as flash are two main storage devices. Solid state memory devices have fast Read/Write (R/W) speed, small form factor, and low power consumption. However, comparing to HDD, solid state memory devices have higher manufacturing cost per bit and are difficult to scale in density.

Thus, there is a need in the art for methods and apparatus for fabricating a memory device that has fast R/W speed, small form factor, low cost, high density, low power consumption and scalable.

### SUMMARY OF THE INVENTION

According to the present invention, techniques for manufacturing objects are provided. More particularly, the invention provides a method and device for fabricating high density memory device. Similar to a Hard Disk Drive (HDD), the integrated memory device is consisted with a rotating media plate and a Read/Write (R/W) head on a movable suspension. The R/W head moves normal to the rotating movement of the media substrate. Unlike HDD where the media plate is coupled to a motor, the media plate is micro fabricated on a semiconductor substrate and is also a motor that has a plurality of ‘teeth’ electrodes that have corresponding stator electrodes. The media plate is actuated and rotated by electrostatic forces instead of magnetic forces used in HDD. The head suspension is also micro fabricated and anchored to an electrostatic comb drive micro actuator. The R/W head is coupled to an air bearing surface (ABS) that allows the R/W head flies over the media surface in close vicinity of a few nanometers.

The R/W head can be based on one of following storage techniques: magnetoresistive, probe-based, and near field scanning optical microscope (NSOM), etc. Those techniques employ one of the modulation techniques including: charge, magnetic, optical modulation on variety of materials including semiconductor, organic, organometallic, ferro-electric, magneto-optic, magnetic and phase change media.

Control IC can also be integrated on-chip with the integrated memory device. In addition, acceleration sensing devices such as MEMS accelerator can be integrated on-chip for anti-shock measures. An array of integrated storage devices can be fabricated on a single chip for larger capacity according to one embodiment of the present invention. Multiple layers of storage devices can also be stacked.

Many benefits are achieved by way of the present invention over conventional techniques. For example, the present technique provides an easy to use process that relies upon conventional technology. In some embodiments, the method provides for an integrated drive storage device based on electrostatic actuation are more power efficient than conventional HDD with magnetic actuation. In other embodiments, the method provides for the integrated disk storage device to have higher mechanical bandwidth than conventional HDD, which yields fast access speed and short R/W cycle time. Furthermore, the integrated disk storage device is fabricated on a semiconductor substrate which has higher bit density and scalability than conventional HDD. Additionally, the method provides a process that is compatible with conventional semiconductor and MEMS fabrication process technology without substantial modifications to conventional equipment and processes. Preferably, the invention provides for an integrated disk storage device including Integrated Circuits and sensing elements for various applications.

Depending upon the embodiment, one or more of these benefits may be achieved. These and other benefits will be described in more throughout the present specification and more particularly below. Various additional objects, features and advantages of the present invention can be more fully appreciated with reference to the detailed description and accompanying drawings that follow.

### BRIEF DESCRIPTION OF THE DRAWINGS

FIG. 1 is a simplified top-view diagram illustrating components of an integrated storage device according to one embodiment of the present invention.

FIG. 2 is a simplified cross section diagram illustrating components of an integrated storage device according to one embodiment of the present invention.

FIG. 3A is the top view of an array of integrated storage devices be fabricated on a single chip according to one embodiment of the present invention.

FIG. 3B is the side view of stacked multiple layers of storage devices according to one embodiment of the present invention.

FIG. 4 is a simplified side view illustrating components of magnetic R/W heads based storage device according to one embodiment of the present invention.

FIG. 5 is a simplified side view illustrating components of tip-based R/W head storage device according to one embodiment of the present invention.

FIG. 6A is simplified side view illustrating components of NSOM based storage device according to one embodiment of the present invention.

### DETAILED DESCRIPTION OF THE INVENTION

According to the present invention, techniques for manufacturing objects are provided. More particularly, the invention provides a method and device for fabricating high density memory device.

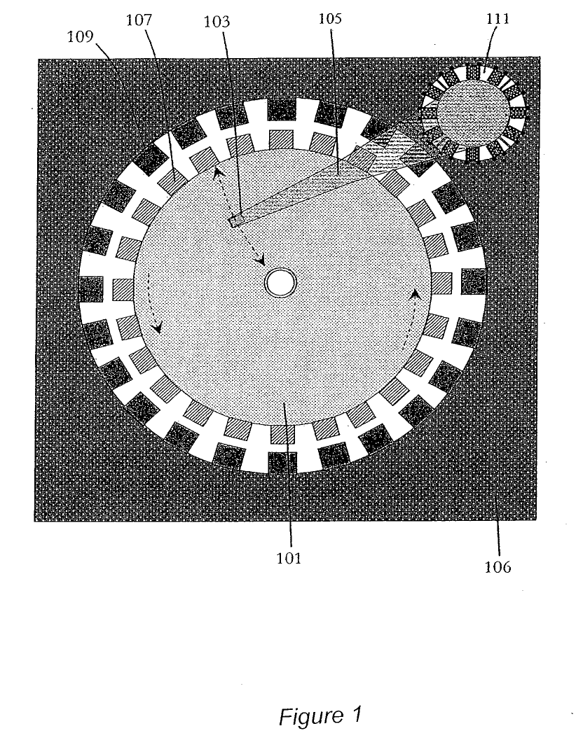

FIG. 1 is a simplified top-view diagram illustrating components of an integrated storage device according to one embodiment of the present invention. As illustrated, the integrated memory device is consisted with a rotating media plate 101 and a Read/Write (R/W) head 103 on a movable suspension 105, similar to a Hard Disk Drive (HDD). Unlike HDD, the media plate is micro fabricated on a substrate 106. Both the plate and head suspension are actuated by electrostatic forces instead of magnetic forces used in HDD. The media plate is also the rotor and has a plurality of ‘teeth’ electrodes 107 that have corresponding stator electrodes 109. The head suspension is micro fabricated and anchored to a comb drive actuator which is also micro fabricated. The R/W head can be based on one of following storage techniques: magnetoresistive, aerodynamic sensing, capacitive sensing, Scanning Tunneling Microscope (STM), Field Emission Probe (FEP), Atomic Force Microscope (AFM), and near field scanning optical microscope (NSOM), etc.

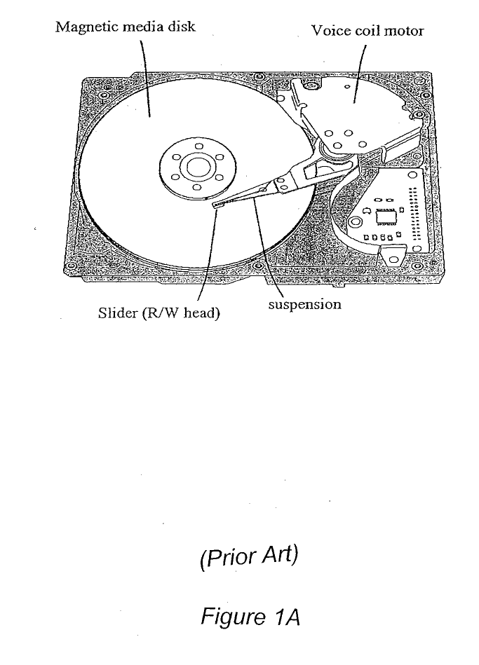

FIG. 2 is a simplified cross section diagram illustrating components of an integrated storage device according to one embodiment of the present invention. As illustrated, the rotating media plate 101 is fabricated directly on a supporting substrate 106. The media plate is supported by an air or fluidic bearing 201 at the center. The suspension arm 105 and its combdrive actuator 111 are micromachined on a separate substrate 203. The suspension material can be single crystal silicon, poly silicon, metal such as Aluminum, Nickel, Copper, or metal alloy. The R/W head 103 is attached to the end of the suspension arm. The two substrates are aligned and bonded with a spacer 206 to couple the R/W head to the media plate. The bonding can semi hermetic and fully hermetic. As shown, control IC 205 can also be integrated on-chip. In addition, acceleration sensing devices such as MEMS accelerator can be integrated on-chip for anti-shock measures. As depicted in A-A view of details of the R/W head, the suspension 105 and air bearing surface (ABS) 207 allows the R/W head element 209 flies over the media surface 211 in close vicinity of a few nanometers.

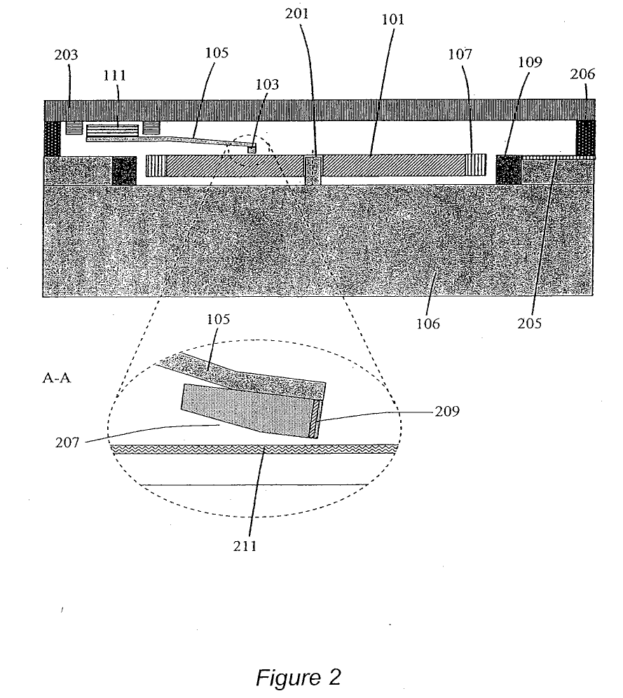

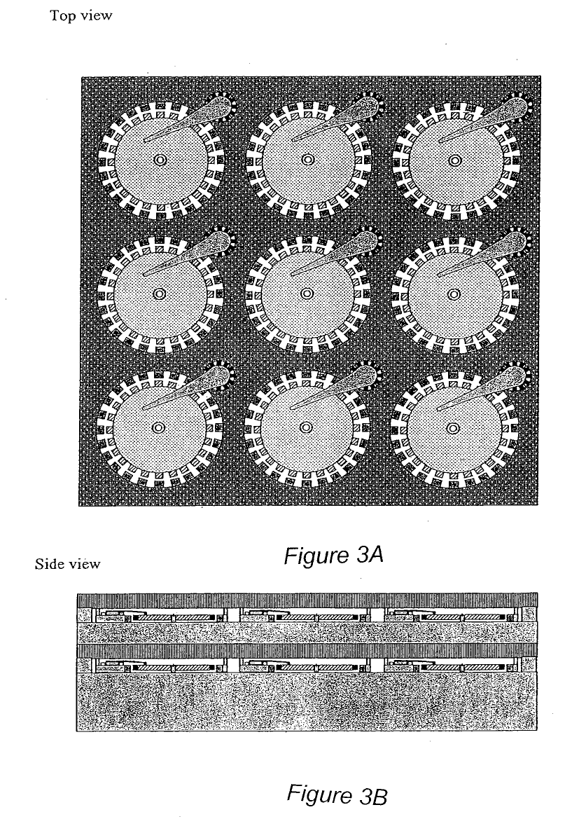

As depicted in the top view in FIG. 3, an array of integrated storage devices are fabricated on a single chip for larger capacity according to one embodiment of the present invention. According to another embodiment of the present invention, multiple layers of storage devices are stacked as shown in the side view diagram. Each storage device is individually operated and controlled.

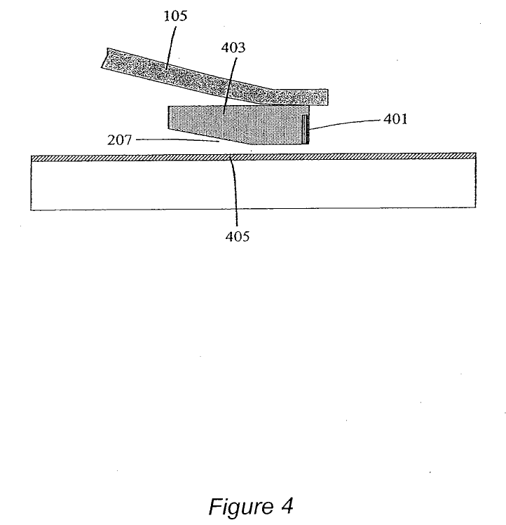

FIG. 4 is a simplified side view illustrating components of magnetic R/W heads based storage device according to one embodiment of the present invention. As illustrated, a magnetic R/W element 401 is coupled to a slider 403. The slider is attached to the suspension 105. Part of the slider is an air bearing surface 207 that creates a lift force when the head flying over the media surface 405. The lift force allows the slider follows the topographic media surface in close distance without crashing into it. The magnetic media layer can be either continuous or patterned depending on applications.

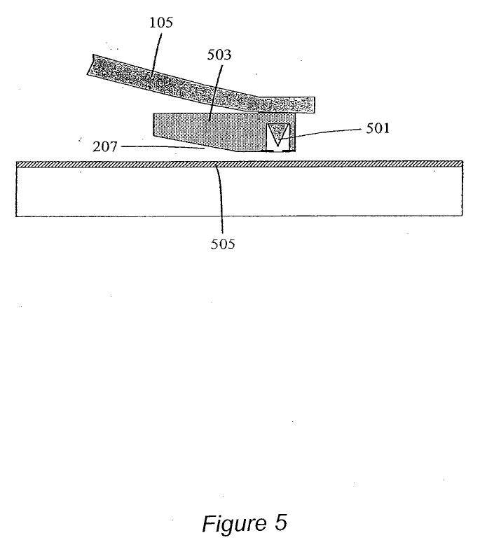

FIG. 5 is a simplified side view illustrating components of tip-based R/W head storage device according to one embodiment of the present invention. As illustrated, tip R/W element 501 is coupled to a slider 503. The slider is attached to a suspension 105. Part of the slider is an air bearing surface 207 that creates a lift force when the head flying over the media surface 505. The lift force allows the head follows the topographic media surface in close distance without crashing into it. The tip R/W techniques include scanning tunneling microscope (STM), field emission probe (FEP), atomic force microscope (AFM), etc.

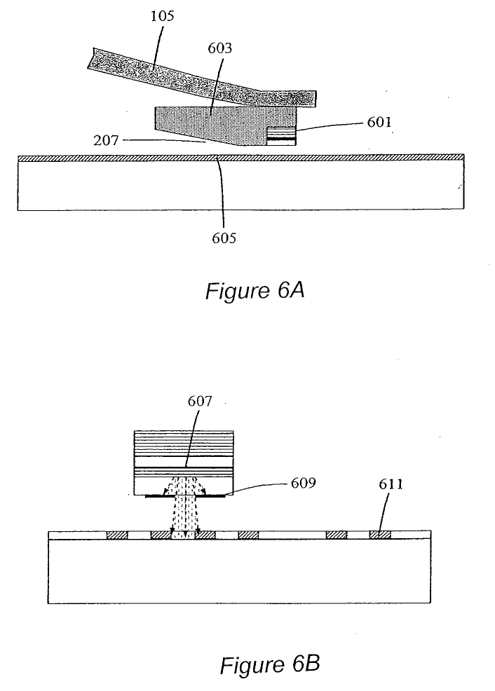

FIG. 6A is simplified side view illustrating components of NSOM based storage device according to one embodiment of the present invention. As illustrated, a Near Field Scanning Optical Microscope (NSOM) R/W element 601 is coupled to a slider 603. The air bearing 207 on the slider and the suspension keep the R/W element close to the media surface. In one particular embodiment, the NSOM is a Vertical-Cavity Surface-Emitting Laser (VCSEL) element 607 with an aperture 609 that can read and write bit information on a phase change media 611 similar to a CD or DVD as shown in FIG. 6B. In another embodiment, the NSOM is a fiber or integrated wave guide that can read and write bit information. Since the R/W element is closer to the media surface, NSOM has much higher optical resolution and bit density than CD or DVD.

It is also understood that the examples and embodiments described herein are for illustrative purposes only and that various modifications or changes in light thereof will be suggested to persons skilled in the art and are to be included within the spirit and purview of this application and scope of the appended claims.

1. A disk drive apparatus comprising:
a substrate member, the substrate member comprising:
an electro-static micro-motor provided within a first portion of the substrate member, the electro-static micro-motor having a bearing support member having a first end and a second end, the first end being coupled to a portion of the substrate member;
a platter integrated into the electro static micro-motor toward the second end of the bearing support member, the platter having a surface region;
a memory media formed overlying the surface region;
a suspension having a first end and a second end, the first end being coupled to a second portion of the substrate; and
a read/write head coupled to the second end of the suspension.

2. The apparatus of claim 1 wherein the first end of the suspension is coupled to a second substrate, the second substrate being coupled to the second portion of the substrate.

3. The apparatus of claim 1 wherein the substrate comprises a silicon material.

4. The apparatus of claim 1 wherein the substrate comprises a glass or quartz material.

5. The apparatus of claim 1 wherein the platter comprises a diameter of about 1 inch and less.

6. The apparatus of claim 1 further comprising one or more integrated circuit elements formed overlying a third portion of the substrate.

7. The apparatus of claim 1 wherein a plurality of drive members is operably coupled to one or more regions of the electrostatic micro-motor.

8. The apparatus of claim 7 wherein the micro-actuator device comprises a comb drive member, the comb drive member being configured to move the read/write head from a first spatial region overlying the platter to a second spatial region overlying the platter.

9. The apparatus of claim 1 wherein the platter rotates at about 7,000 revolutions per minute and greater.

10. The apparatus of claim 1 wherein the read/write head is integrated on a slider device, the slider device being operably configured to be disposed adjacent to a surface region of the memory media, the slider device being coupled to the suspension, the suspension being micro-machined.

11. The apparatus of claim 1 wherein the read/write head is selected from a magnetic R/W element, a physical tip, field emission element, laser device.

12. The apparatus of claim 1 wherein the memory media is characterized by magnetoresistive, tip-based, and near field scanning optical microscope (NSOM).
